(19) United States
(12) Patent Application Publication
(10) Pub. No.: US 2012/0127034 A1
(43) Pub. Date: May 24, 2012

(54) Phased Array Antenna with Reduced Component Count

(75) Inventor: Daniel Francis DiFonzo, Rockville, MD (US)

(73) Assignee: RAYSAT ANTENNA SYSTEMS, L.L.C., McLean, VA (US)

(21) Appl. No.: 13/296,800

(22) Filed: Nov. 15, 2011

Related U.S. Application Data
(60) Provisional application No. 61/415,565, filed on Nov. 19, 2010.

(51) Int. Cl. H01Q 3/22

(52) U.S. Cl. 342/375

(57) ABSTRACT

A phased-array antenna with electronic beam steering that provide simultaneous operation at transmit and receive frequencies and polarization control is disclosed. The antenna architecture reduces the number of beam steering and polarization control devices used compared to conventional array designs. The extremely compact, low-loss, and largely passive design reduces the number of active amplifiers needed using micro-electromechanical systems MEMs and advanced micro-coaxial circuits.

### CROSS-REFERENCE TO RELATED APPLICATION

This application claims the benefit of U.S. Provisional Patent Application Ser. No. 61/415,565, filed on Nov. 19, 2010, which is hereby incorporated by reference as an example embodiment.

### TECHNICAL FIELD

The present disclosure relates to microwave phased array antennas, and more particularly to phased array antennas with electronic beam steering that provide simultaneous operation at transmit and receive frequencies and polarization control.

### BACKGROUND

Phased array antenna applications include, but are not limited to communications, sensors, and radar. There is a need for antennas that can steer their beam or beams electronically or with a combination of electronic control and mechanical beam steering. Electronically Steered Antennas (ESAs) have the advantages that they can occupy a smaller volume than conventional reflector antennas and can steer their beams rapidly without requiring moving parts. Example applications include radar, satellite communications to and from moving vehicles, aircraft, and boats (communications on the move or COTM), and communications with satellites in non-geostationary orbits.

For certain applications, phased array antennas control aspects of the polarization of the received and transmitted signals. For example, an antenna terminal communicating with satellites in the Ku-band Fixed Satellite Service (FSS) must be able to adjust the linear polarization orientation, or tilt angle, of the radiated and received signals depending on the geographic location of the terminal relative to the satellite's geostationary orbit longitude. Other applications such as polarization diversity systems may use transmit and receive signals that are orthogonally polarized.

A phased array antenna may provide simultaneous operation over separate transmit and receive frequencies. This operation is called frequency division duplex (FDD) and is sometimes less precisely called “full duplex.” It is distinguished from time division duplex (TDD), sometimes less precisely called “half duplex”, where transmit and receive functions occur at different time intervals. In FDD operation, to prevent receive signal degradation, the antenna system includes protection for the receiver subsystem to prevent overload by the stronger transmitter signal.

Some conventional array architectures use separate antenna apertures for transmit (Tx) and receive (Rx). This permits separate optimization for each frequency band and reduces the requirements for filters necessary to isolate the strong transmit frequency signals from the receiver. However, requiring two apertures results in a larger overall physical area or footprint for a given set of antenna performance requirements such as the transmit gain, the equivalent isotropically radiated power (EIRP), and the ratio of receive gain to the noise temperature (G/T). Moreover, for a given restriction on total antenna area, the use of separate apertures reduces the available area and gain of each aperture compared with a single aperture that fully utilizes the available area for both transmit and receive functions. Some arrays may interleave the elements of the transmit and receive apertures thereby appearing to occupy a common area for transmit and receive functions. However, interleaving generally alternates transmit and receive array elements across the aperture and demands a larger spacing between array elements having the same function. This severely limits the range of allowable beam steering or scan angles, and could even preclude beam scan.

There is a need for phased arrays that can simultaneously transmit and receive frequency division duplex operation in a common aperture and provide beam steering and polarization control at both frequencies. Moreover, there is a need for such arrays that can accomplish these functions with a minimum number of associated circuit components.

### SUMMARY

This Summary is provided to introduce a selection of concepts in a simplified form that are further described below in the Detailed Description. This Summary is not intended to identify key features or essential features of the disclosure.

A phased array antenna that provides: 1) electronic beam steering, 2) simultaneous frequency division duplex operation through a single aperture at different transmit and receive frequencies, and 3) polarization control is disclosed. Various embodiments include a single bidirectional beam steering and polarization control circuit at each array element or group of elements for spatially coincident receive and transmit beams and orthogonal polarizations. These orthogonal polarizations may be general, including linear, elliptical, or circular.

In further embodiments, each element of a phased array uses one or more transmission lines as delay lines or phase shifters. These delay lines may be implemented in several forms including, but not limited to, waveguides, printed circuits such as microstrip or stripline, and micro-coaxial transmission lines. Different switch configurations may be used to select different delay lines through electronic digital control, resulting in different signal delays to control the polarization states and beam steering or scan directions of the signals transmitted from and received by the phased array antenna. Switches may include microelectromechanical systems (MEMS). Further, the MEMS circuits may contain the switches and delay lines in a miniature-integrated package. Other embodiments are described below.

### BRIEF DESCRIPTION OF THE DRAWINGS

FIG. 1 illustrates a single array element and associated circuitry of a transmit-receive electronically steered array (ESA) architecture according to various embodiments.

FIG. 2 illustrates various aspects of an example beam steering and polarization control circuit for transmit (Tx) mode operation according to various embodiments.

FIG. 3 illustrates various aspects of a beam steering and polarization control circuit according to various embodiments.

FIGS. 4A and 4B illustrate the scattering matrices for several forms of hybrid couplers that can be components in a beam steering and polarization circuit according to several embodiments.

FIG. 5 illustrates a single array element and associated circuitry of an electronically steered array (ESA) architecture according to various embodiments

FIG. 6 illustrates a polarization and beam steering circuit operating in receive mode according to various embodiments.

FIG. 7 illustrate the same polarization and beam steering circuit as in FIG. 6 operating in transmit (Tx) mode according to various embodiments.

FIG. 8 illustrates beam steering, phase shift, and time delay for a fixed beam steering angle of an ESA across a frequency band.

FIG. 9 illustrates phase versus frequency properties of phase or time delay control devices.

FIG. 10 illustrates various aspects of an example discrete time delay device according to various embodiments.

FIG. 11 depicts a digital phase or time-delay circuit according to various embodiments.

### DETAILED DESCRIPTION

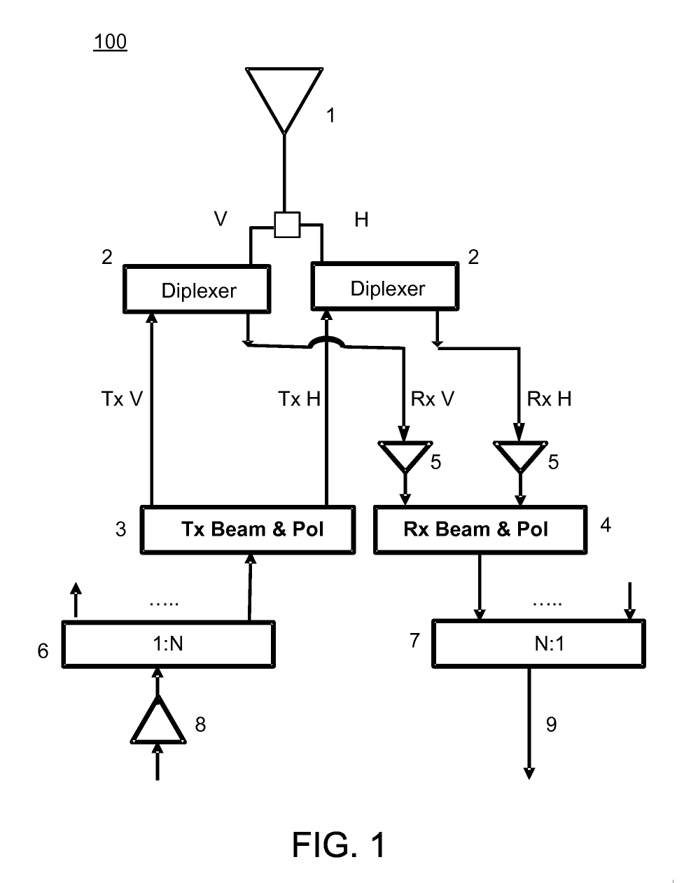

In order to facilitate the description of the invention, it is useful to describe an example array architecture that utilizes separate receive and transmit beam steering and polarization circuits at each array element to achieve a single aperture for both receive and transmit functions. FIG. 1 depicts one embodiment of a transceiver circuit 100 for one element of an electronically steered array (ESA). This ESA architecture uses all available aperture elements for both transmit and receive in FDD operation, and includes dual polarizations. It incorporates diplexers for each polarization and separate polarization and beam steering circuits for transmit and receive.

Element circuitry 100 includes an antenna 1, which may be one of multiple dual polarized radiating elements of an array (e.g., a broadband or dual band patch antenna, waveguide horn antenna, or fragmented antenna). Element circuitry 100 operates over both transmit and receive bands. In one illustrative embodiment, for a Fixed Satellite Service (FSS) Ku-band, the receive band is from 10.95 GHz to 12.75 GHz and the transmit band is from 13.75 GHz to 14.5 GHz. Thus, in this embodiment antenna 1 may operate over a frequency range of 10.95-14.5 GHz. In other examples, the required operating frequency range will depend on transmit and receive frequencies used.

Antenna 1 includes a first polarization, labeled “vertical” or “V,” and a second polarization, labeled “horizontal” or “H,” having an electric field orthogonally polarized with respect to the vertical polarization. While in various embodiments the polarizations may be linearly polarized vertically and horizontally with respect to a frame of reference (e.g., the earth's surface), the vertical (V) and horizontal (H) labels are used for convenience only. Various other embodiments may include circular or elliptical polarizations and the tilt angles or alignment of the polarization ellipse axes may be oriented with respect to other frames of references.

For each polarization V and H, element circuitry 100 includes a diplexer 2, which separates the transmit (Tx) and receive (Rx) signals for each polarization component. The two diplexers 2 have four signal component ports: transmit-vertical (TxV), receive-vertical (RxV), transmit-horizontal (TxH), and receive-horizontal (RxH). The transmit-vertical (TxV) and transmit-horizontal (TxH) components may emerge from a Tx beam steering and polarization control circuit 3, and the receive-vertical (RxV) and receive-horizontal (RxH) components may be fed to an Rx beam steering and polarization control circuit 4, which are further described below. Low noise amplifiers (LNAs) 5 may be used to mitigate the impact of circuit losses in the RxV and RxH signal paths.

The Rx beam and polarization circuit 4 conditions and combines the RxV and RxH signals to output the receive signal of the single antenna element 1 properly conditioned with respect to the polarization of the receive electromagnetic wave incident on the array, and also properly phased with respect to the other array elements based on the receive beam pattern to be formed by the array. The output of the Rx beam and polarization circuit 4 may be fed to an N:1 power combiner 7, which combines the outputs of the Rx beam and polarization circuits of other array elements (not shown). In various applications, the composite signal output 9 from the N:1 power combiner 7 may be further amplified and sent to a down-converter and modem.

In the transmit direction, a modem and up-converter may generate a Tx signal, which is amplified by amplifier 8 and input to a 1:N power divider 6. One of the N output ports of power divider 6 is connected to the Tx beam steering and polarization control circuit 3. The other N−1 output ports of power divider 6 are connected to the Tx beam steering and polarization control circuits of other elements of the array (not shown). Although not shown here, other Tx amplifiers may be incorporated, for example, at the outputs of the 1:N divider 6 and/or between the Tx beam and polarization circuit 3 and the Tx ports of the two diplexers 2.

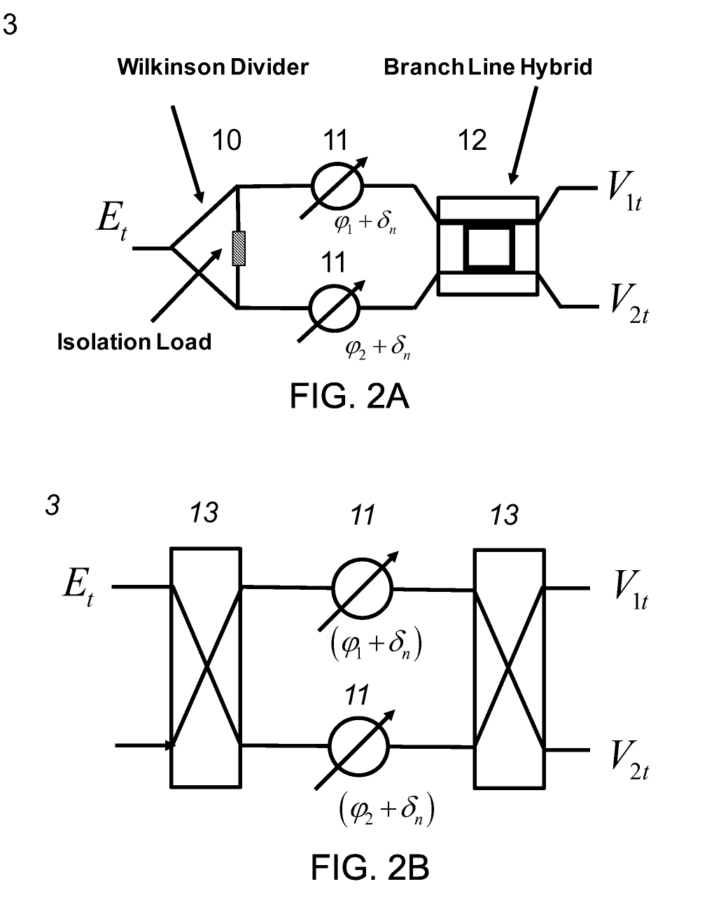

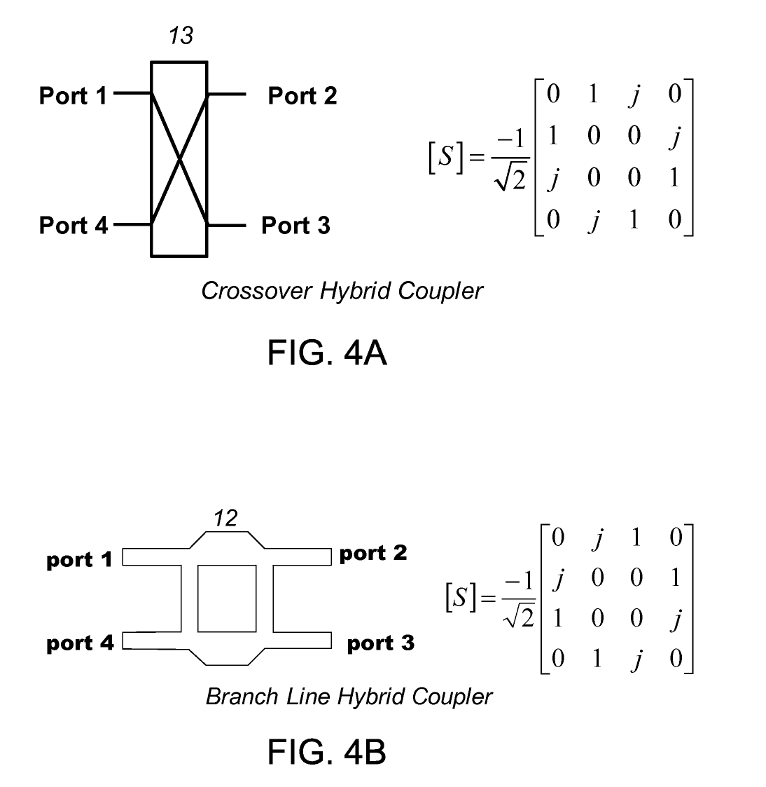

One example of a transmit beam steering and polarization control circuit 3 includes the variable power divider (VPD) illustrated in FIG. 2A. The variable power divider, shown for illustration, includes an in-phase power divider, such as a Wilkinson divider 10, two phase control devices 11, and a four-port circuit such as a branch line hybrid 12. As shown in FIG. 2B, the variable power divider may also be realized using two crossover hybrid couplers, such as 3 dB, 90-degree or quadrature hybrid couplers. Input-output properties of the crossover hybrid coupler and branch line hybrid coupler are typified by the scattering matrices of FIGS. 4A and 4B respectively. Other implementations may include waveguide “magic tee,” stripline geometries, or other ring hybrid geometries. Further implementations may include various combinations of couplers, dividers, and geometries mentioned above.

For the variable power dividers (VPDs) shown in FIG. 2A and FIG. 2B the phase shifters or time delay components 11 may be configured to shift the phase of incoming signals by φ₁+δₜ, and φ₂+δₙ, where δₙ, represents the phase shift of the nth element relative to adjacent elements in the array. For a signal input, Eₜ, the relative outputs, V₁ₜ and V₂ₜ, may be varied such that the signal appears all at one port or appears all at the other port or is proportioned to have values in between. The power apportionment is determined by the phase difference Δφ=φ₂−φ₁ as follows, with the phase terms δₙ (not shown) common to both ports:

$$\begin{matrix}{V}_{1 t} -> {E}_{t} cos ( \frac{Δ ϕ}{2} + \frac{π}{4} ) & ( 1 ) \\ {V}_{2 t} -> {E}_{t} sin ( \frac{Δϕ}{2} + \frac{π}{4} ) & ( 2 )\end{matrix}$$

for example, setting Δφ=−π/2 causes the signal at port V₂ₜ, to vanish and directs all the available power to port V₁ₜ.

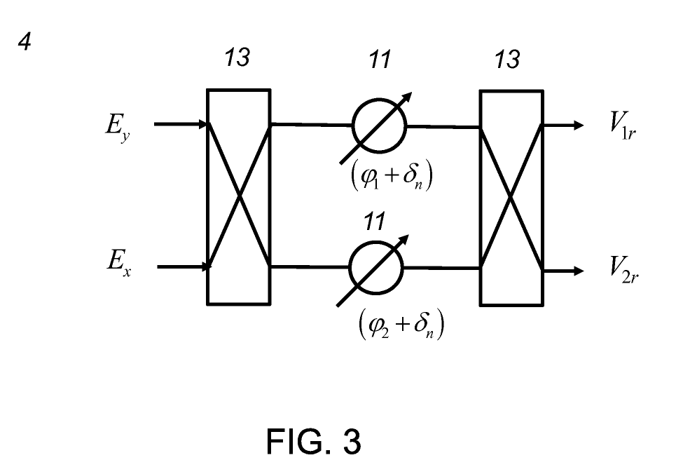

FIG. 3 illustrates an alternative variable power divider implementation (similar to FIG. 2B), shown here for Rx operation that uses back-to-back hybrid couplers 13 with phase devices 11 in between. The operation of such variable power dividers will be described further in the context of the subject invention.

The circuit illustrated in FIG. 1 includes four phase shift devices per radiating element 1.

These devices are significant drivers of the cost of phased arrays. For N elements, the FDD array with polarization control may use 4N phase shifters, 2N diplexers, 8N hybrid couplers and possibly 2N low noise amplifiers.

The subject invention uses fewer components and, in particular, reduces the number of phase control devices and active amplifiers. Further, to the extent that the number of active amplifiers can be reduced, power and thermal dissipation within the array structure may be reduced.

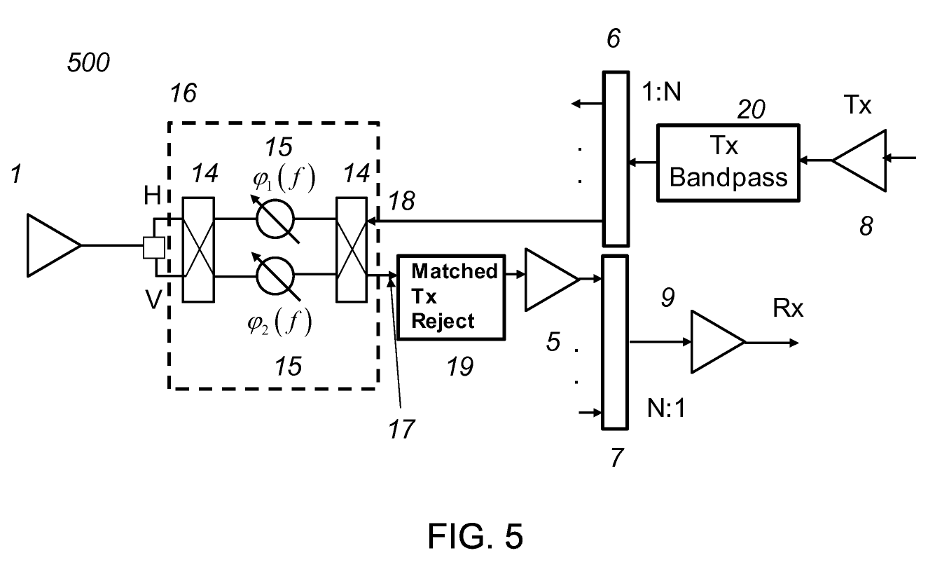

FIG. 5 depicts an embodiment of a single array element transceiver circuit in a preferred ESA architecture 500. The dual polarized radiating element 1 may have a wide variety of forms, including a waveguide antenna, broadband patch antenna or fragmented antenna. The embodiment of FIG. 5 substantially reduces the number of components while allowing the FDD features of coincident transmit and receive beam steering and polarization control. The transmit beam and the receive beam produced by the array of FIG. 5 may be formed in the same spatial direction and having orthogonal polarizations. Furthermore, by using discrete time delay devices in the polarization and beam steering circuit 16, the Rx and Tx beams may maintain coincident beam directions over the Tx and Rx frequency bands, thereby reducing or even eliminating beam controller processing or look-up tables to maintain array calibration.

One feature of the subject architecture 500 is the bidirectional use of a single polarization and beam steering circuit 16 as illustrated in FIG. 5. Circuit 16 may be similar to the circuit illustrated in FIG. 3, but configured in architecture 500 for both transmit and receive functions simultaneously. The following paragraphs further describe the bidirectional operation of this circuit.

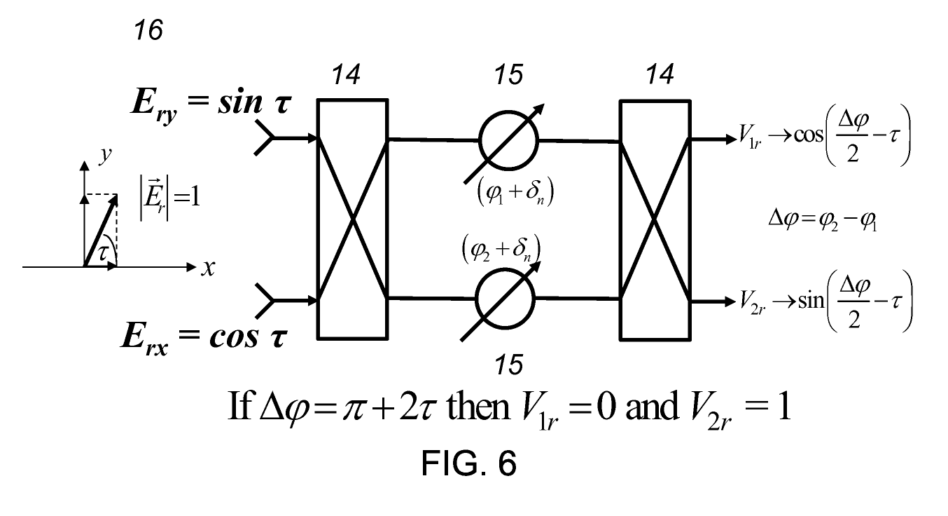

FIG. 6 illustrates one example of circuit 16 in architecture 500, receiving from antenna 1 an illustrative unit-amplitude linearly polarized incident electric field vector in the receive band with a tilt angle, τ, relative to array coordinate axes x and y (i.e., “horizontal” and “vertical,” respectively in the example of FIG. 1). The variable power divider circuit 16 incorporates hybrid couplers 14, and phase and/or time delay devices 15 having prescribed phase vs. frequency characteristics corresponding to substantially constant time delay over the transmit and receive bands (as will later be described more fully). For a linearly polarized incident wave having tilt angle τ, the “horizontal” or x-directed polarization component produces a signal proportional to Eᵣₓ=cos τ and the “vertical” or y-directed polarization component produces a signal proportional to E_{ry}=sin τ. The difference between the two phase shifts, Δφ=φ₂−φ₁, can be chosen to direct all the incident power to one of the two output ports, V₁ᵣ or V₂ᵣ regardless of the incident tilt angle of the incoming signal, thereby maximizing the receive response to that polarization. Specifically, the output signals for the circuit in FIG. 6 (with common phase terms δₙ not shown) are:

$$\begin{matrix}{V}_{1 r} -> cos ( \frac{Δϕ}{2} - τ ) & ( 3 ) \\ {V}_{2 r} -> sin ( \frac{Δϕ}{2} - τ ) & ( 4 )\end{matrix}$$

If the phase difference is chosen to be Δφ=φ₁−φ₂=π+2τ, then V₁ᵣ is zero and all of the received signal power is directed to port V₂ᵣ, i.e., V₂ᵣ=1 (not including losses, leakage, etc.). As noted previously, the beam direction is determined by the phase shift or time delay δₙ which appears at both ports. Therefore, in this example, the beam direction is determined by the absolute value of δₙ while the polarization is determined by the phase difference between the phase devices.

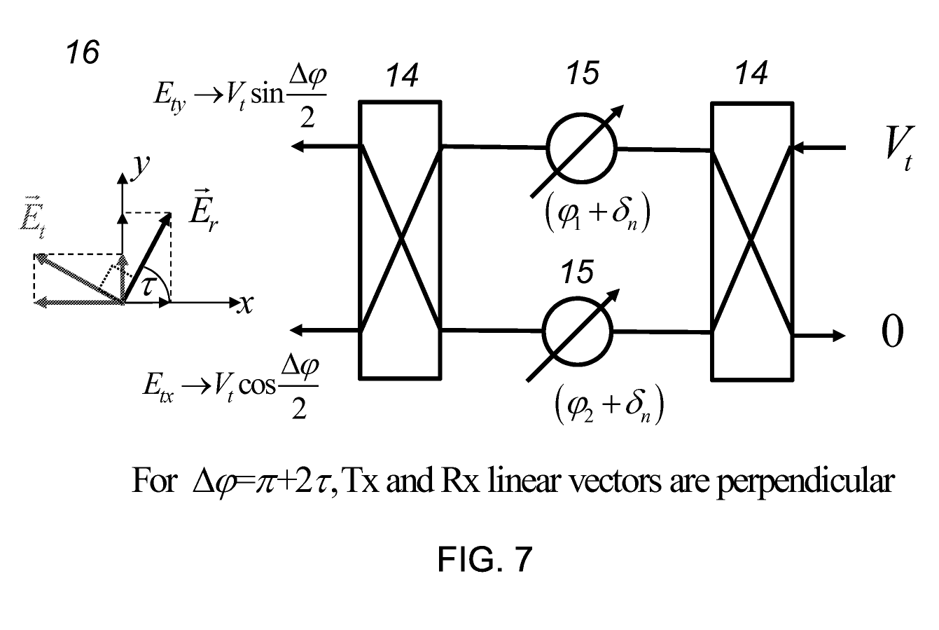

FIG. 7 illustrates the use of circuit 16 in architecture 500 in a bidirectional operation, as compared to the receive-only operation as described with respect to FIG. 6. If the phase difference Δφ is chosen to direct all the receive signal to port 2 of FIG. 6 (i.e., Vᵣ₂), then port 1 (or upper port) in FIG. 7 is available for the transmit function, Vₜ. In this case, the two back to back hybrid RF couplers 14 with the two phase shifters 15 connected in between may be operated in the “reverse” direction (i.e., transmit direction) simultaneously with operation in the receive direction. As with the receive case, tracing the signal from right to left in FIG. 7 produces transmit signals at the array element ports x and y that, when radiated, produce a linearly polarized wave that is orthogonal to that of the receive signal. This may be understood in more detail as described in the next paragraphs.

In FIG. 7, circuit 16 accepts a transmit signal input Vₜ (e.g., from power divider 6 in FIG. 5), at port 1 (the upper right port) input of the first coupler 14. Port 2 (the lower right port) in FIG. 7, labeled “0”, is used for the receive signal and has natural isolation from the upper right port due to the directivity of the coupler. Determination of the outputs E_{ty} and Eₜₓ depends on the phase difference between the phase or time delay devices as shown in FIG. 7 and reproduced below:

$$\begin{matrix}{E}_{ty} -> {V}_{t} sin \frac{Δϕ}{2} & ( 5 ) \\ {E}_{tx} -> {V}_{t} cos \frac{Δϕ}{2} & ( 6 )\end{matrix}$$

By choosing be Δφ=π+2τ, the transmit polarization is orthogonal to that of the receive signal. The common time delay criterion for beam steering in the transmit mode is substantially the same as for the receive mode so that the same circuit, having the same common phase difference, may be used for both receive and transmit.

The phase, δₙ which is not shown explicitly in the formulas, is a value common to both outputs, and may be adjusted, for example to produce a phase shift (common to both ports of the circuit) with respect to the other array elements for beam steering, or it may be adjusted to compensate for other phase offsets.

With reference to FIG. 5, dual polarized antenna element 1 may operate over the full range of transmit (Tx) and receive (Rx) frequencies provided that the phase vs. frequency characteristics of the phase shifters or time delay elements is such that the time delay is substantially constant for the Tx and Rx frequency bands (as will be discussed further). For example, in one illustrative embodiment, for a FSS Ku-band, the receive band is from 10.95 GHz to 12.75 GHz and the transmit band is from 13.75 GHz to 14.5 GHz. Thus, antenna element 1 may operate over a frequency range of 10.95-14.5 GHz. In other examples, the required operating frequency range will depend on transmit and receive frequencies used.

In further description of the preferred array architecture 500 of FIG. 5, the vertical (V) and horizontal (H) antenna ports are connected to a single four-port beam steering and polarization circuit 16 comprising two hybrid couplers 14 and two phase or time delay control devices 15 that provides simultaneous bidirectional performance. The receive signals are all directed to the receive port 17 based on adjusting the phase delays in the phase control devices 15, as discussed above with respect to FIGS. 5 and 6. The Tx signal entering the circuit's Tx port 18 will emerge from the antenna element and radiate a transmit signal with a polarization orthogonal to the receive signal.

As in FIG. 1, antenna 1 of FIG. 5 includes a first polarization, labeled “vertical” or “V,” and a second polarization, labeled “horizontal” or “H,” having an electric field orthogonally polarized with respect to the vertical polarization. While in various embodiments the polarizations may be linearly polarized vertically and horizontally with respect to a frame of reference (e.g., the earth's surface), the vertical (V) and horizontal (H) labels are used for convenience only.

Various other embodiments having the architecture of FIG. 5 may include linear, circular, and/or elliptical polarizations with respect to other frames of references. For example, the phase difference Δφ may be varied to direct different ratios of power to each port for Rx and Tx. By varying Δφ, linear polarizations at different angles, circular polarizations (e.g. right hand circular and left hand circular) and more general elliptical polarizations may be generated while maintaining orthogonality between Tx and Rx polarizations. Such embodiments may be used in, for example, X-band, K/Ka band, and Q-band communications having circular polarization (CP).

Two elliptical signals have orthogonal polarization states if the axial ratios of their polarization ellipses are the same, the major axes of the polarization ellipses of the signals are perpendicular to one another, and the polarization vectors of each signal have opposite senses of polarization (i.e., left hand vs. right hand). A circular polarization is a specific case of elliptical polarization where the major and minor axes of the ellipse are the same. A linear polarization may also be considered a special case of elliptical polarization where the minor axis is zero. As such, linearly polarized signals with the same magnitude and perpendicular tilt angles have orthogonal polarization states.

In various embodiments, Δφ may be varied in the same or similar manner as in circular and/or elliptical polarizations, but in small/incremental steps to adjust the axial ratio to compensate for axial ratio degradation due to beam steering. Axial ratio degradation is a change in the ratio of Tx and Rx power between first and second polarizations due to non-idealistic behavior of the circuit, which may, for example, result in a change in tilt angle. For example, as a beam is scanned or steered away from the array normal, mutual coupling of energy among the array elements is known to degrade axial ratio in scanned beams. Incremental and/or small adjustments of Δφ, in various examples, may be used to correct for the degradation in axial ratio due to the mutual coupling.

The receive port 17 may be fed to a filter 19 that has a good impedance match to the polarization and beam control circuit 16. This filter may be used to augment the natural isolation between the hybrid coupler ports in 16 in order to protect the low noise amplifier (LNA) 5 from the stronger transmit signal entering the polarization and beam control circuit at 18. The filter may optionally feed a low noise amplifier (LNA) 5. The LNA output may be connected to an N:1 power combiner 7, which combines the outputs of the LNA 5 of other array elements (not shown). In various applications, the composite signal output 9 from the N:1 power combiner 7 may be sent to a down-converter and modem.

The transmit port 18 may be connected to one of the N output ports of a 1:N power divider 6. The other N−1 output ports of 6 are connected to the Tx inputs of other elements of the array (not shown). The 1:N power divider 6 may be driven by transmit amplifier 8 through an optional transmit bandpass filter 20. Although not shown here, additional Tx amplifiers may be incorporated, for example, between the Tx input 18 and the power divider 6. A modem and up-converter may generate a Tx signal that drives amplifier 8.

The hybrid couplers 14 may be 3 dB, 90-degree hybrid couplers having the same properties as couplers 13 in FIG. 3. The hybrid coupler closest to the transmit power divider 6 provides some isolation of the Tx signal between ports 18 and 17. This isolation depends on the directivity of the hybrid coupler. In various embodiments, the isolation may be in the range of 20 dB, but may be more or less, depending on the design of the coupler, the operating frequencies, and the relative strengths of the transmit and receive signals. For example, a hybrid coupler may be designed to isolate transmit signals received at port 18 from port 17 by more than 20 dB, but impedance mismatches at the opposite ports of the hybrid coupler (e.g., ports connected to phase shifters 15) may reflect a portion of the transmit signal energy back to port 17, causing a reduction in the isolation. The impedance mismatches could be caused, for example, by the frequency dependence of the impedances of the phase control devices 15 and the directional couplers 14 operating at two different frequency bands (e.g., Rx and Tx bands).

Depending on the relative strength of the Tx and Rx signals at port 17, and the desired maximum input power to be seen by the low noise amplifier 5 to keep its operation linear, a matched Tx reject filter 19 may be included to provide further reduction of the Tx signal in the receive path while having low insertion loss to the Rx signal.

The Tx reject filter 19 may have a reflection coefficient at the input to this filter that is low at the Tx band to prevent Tx energy reflected back into the beam and polarization circuit 16 at port 17. If reflected back, the reflected energy may be radiated by the element as energy that is cross-polarized to the desired Tx radiated field.

To prevent Tx energy reflected back into circuit 16, various embodiments may include a Tx reject filter 19 that includes a reflection coefficient that is sufficient to keep the cross polarization to low values, e.g. 25-30 dB. As one example, the Tx reject filter 19 may include complementary-pair bandpass-bandstop filters where the Tx energy coupled to port 17 is directed to a dissipative load using an isolator such as a circulator at port 17. The number of sections in the filter is a trade item depending on the required rejection and allowable insertion loss.

If the insertion loss of the circuit up to port 17 and through the N:1 combiner 7 is sufficiently low, e.g., 2 dB, the filter and low noise amplifier may be moved to the output port of combiner 9, thereby sharing the filter/LNA circuit among array elements and further reducing the parts count. In that case, only one filter/LNA circuit is required instead of one for each array element (i.e., N). In certain variations, the divider 6 and combiner 7 may be part of a subarray of the entire array where further combining and dividing among subarrays is accomplished with further layers of components (not shown) in a manner known to the art.

In the embodiment shown in FIG. 5, the polarization and beam control circuit 16 may operate in both directions simultaneously (i.e., FDD operation) and in a lossless fashion (assuming lossless components) such that transmit and receive polarizations are orthogonal, the transmit and receive beams are in the same direction, and the transmit and receive ports are isolated by e.g., the coupler directivity and/or a Tx reject filter 19.

As previously discussed with respect to FIG. 6, for the receive mode, a unit-amplitude field vector having tilt angle, τ, and having polarization components cos(τ) and sin(τ) may enter the phase and polarization control circuit 16 from the H port and V port respectively. Phase control devices 15 are controlled such that Δφ=φ₂−φ₁=π+2τ, which directs the receive energy entirely to the receive port 17. Similarly, the transmit signal may enter the Tx port 18 and encounter the same phase shifts, Δφ=φ₂−φ₁=π+2τ, in the phase and polarization control circuit 16. As a result, circuit 16 outputs transmit polarization components sin(τ) and cos(τ) on the H port and V port respectively, which results in a linearly polarized transmit wave having a polarization orthogonal to the received field vector. For linear polarization, the transmit vector has a tilt angle perpendicular to the receive vector.

In the architecture 500 of FIG. 5, the beam direction may be determined by adding a common phase shift or time delay relative to adjacent elements, δₙ, and the polarizations are determined by the difference in phase shifts, Δφ, at each element. To the extent that the phase control devices have phase vs, frequency responses that behave as constant time delay devices (to be described further below) over the full extent of Tx and Rx bands, the beam direction remains stable with frequency and the Tx and Rx beams maintain the same spatial direction.

Various embodiments utilizing the architecture 500 of FIG. 5 can use fewer components than that of FIG. 1. In particular, architecture 500 reduces the number of expensive phase control devices per array element from four to two. The filtering is also simplified, thereby eliminating two diplexers in favor of a single matched Tx reject filter and a simple Tx bandpass filter.

The circuit of FIG. 5 differs from the circuit of FIG. 1 in other ways. For example, the four-port circuit comprising two hybrid couplers and two phase control devices in FIG. 5 looks superficially like that shown in the architecture of FIG. 1. However, the components of FIG. 5 may be designed to work over the both Tx and Rx bands, whereas the circuit of FIG. 1 utilizes two different beam and polarization devices, each operating at different frequency bands (i.e., the Rx band or the Tx band).

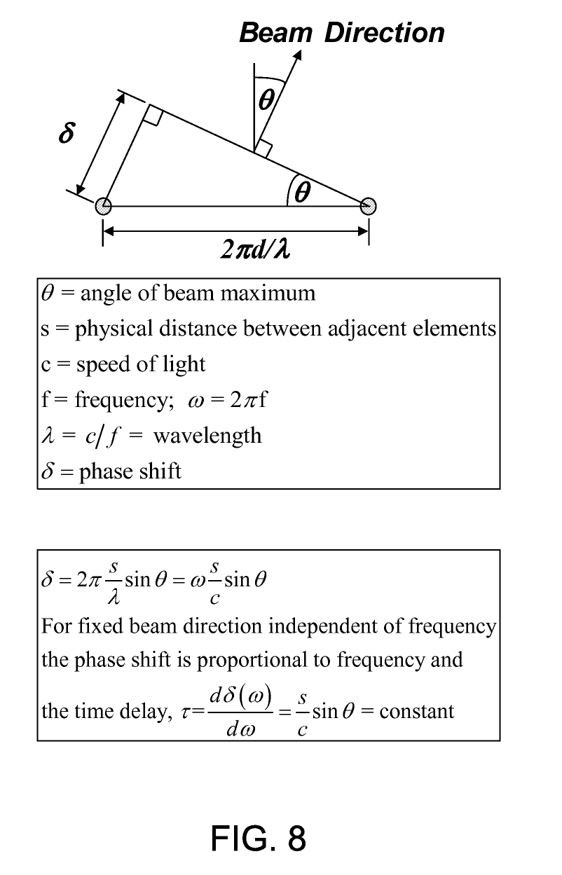

FIG. 8 describes phasing the array elements to produce a beam in a specified direction.

The example is shown for two adjacent elements. For a constant beam direction θ, the phase shift 6 between the signal transmitted from or received by each element may be proportional to electrical distance between the elements, or sin(θ)=δ/(2πs/λ)=cδ/sω=constant. The speed of light c and the physical distances are constant, so δ/ω must be constant. Since time delay is equal to the rate of change in phase with respect to frequency, τ=dδ(ω)/dω, then a fixed time delay corresponds to a constant ratio of δ/ω, which provides a constant beam direction. For beams steered away from the array normal, the phase, δ, may have a prescribed non-zero slope as a function of frequency.

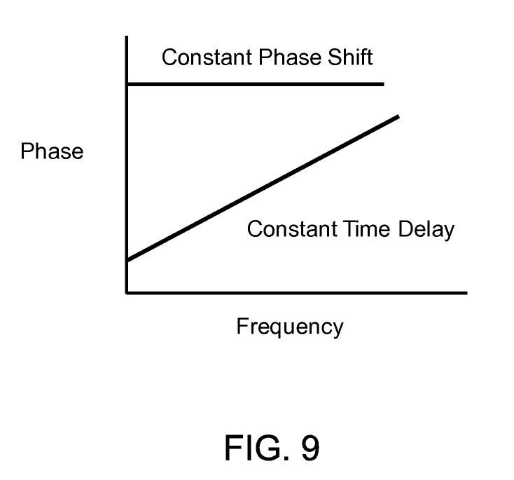

FIG. 9 depicts two cases for phase shift vs. frequency. For some phase devices, the design goal is to achieve constant phase shift across a frequency band. In the array architecture 500 of FIG. 5, phase shift devices 15 may have a constant time delay instead. As shown above with respect to FIG. 8, having a constant time delay means that the phase will vary linearly with frequency, and have a slope according to δ(f)=f(2πs/c) sin θ for a given beam direction.

Various embodiments may include phase control devices 15 having a constant and controllable time delay across a frequency band. These may take several forms including tapped delay lines, bandpass circuit networks such as, for example, pi networks, active devices, and switched line discrete time delay devices such as, for example, back-to-back single pole M throw (SPMT) switches with different line lengths between the like poles of the switches. Various embodiments include devices that have the constant time delay properties while being physically compact and having low insertion loss.

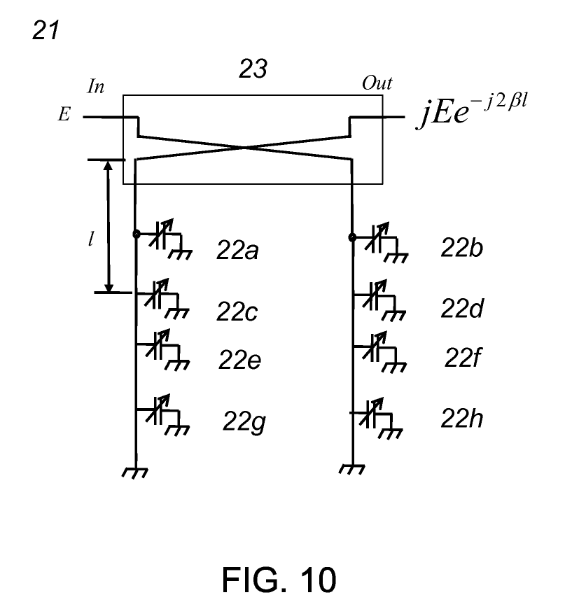

An example embodiment of discrete time delay device 21 is depicted in FIG. 10 which operates as a discrete time delay device having a linear phase vs. frequency dependence over the receive and transmit operating bands. Device 21 may be used in various embodiments for phase control devices 15. When implemented as a microelectromechanical systems (MEMS) device, the insertion loss can be low and the physical size very compact, e.g. area on the order of 50 mm̂2. Other device implementations may also be used to provide a time delay device.

A description of a time delay device 21 follows for illustration of certain embodiments. Other embodiments providing prescribed time delay properties may include devices such as periodically loaded transmission lines, back-to-back SPMT switched lines and bandpass circuits such as Pi networks having prescribed transfer function phase slopes vs. frequency. Device 21 may include a hybrid coupler 23, which divides the power on an input signal E_{IN} between two arms. Each arm may be coupled to a transmission line, with each transmission line having switches (e.g., 22a-22h) connected at specific interval lengths. These switches may take the form of voltage variable capacitors that look like an “open” circuit (low capacitance) or a “short” circuit (high capacitance) depending on the applied voltage. The switches are opened or shorted in sets, with switches connected at the same length along each transmission line switched together (i.e., 22a-b, 22c-d, 22e-f, and 22g-h). When configured as a “short” each switch connects the transmission line to ground.

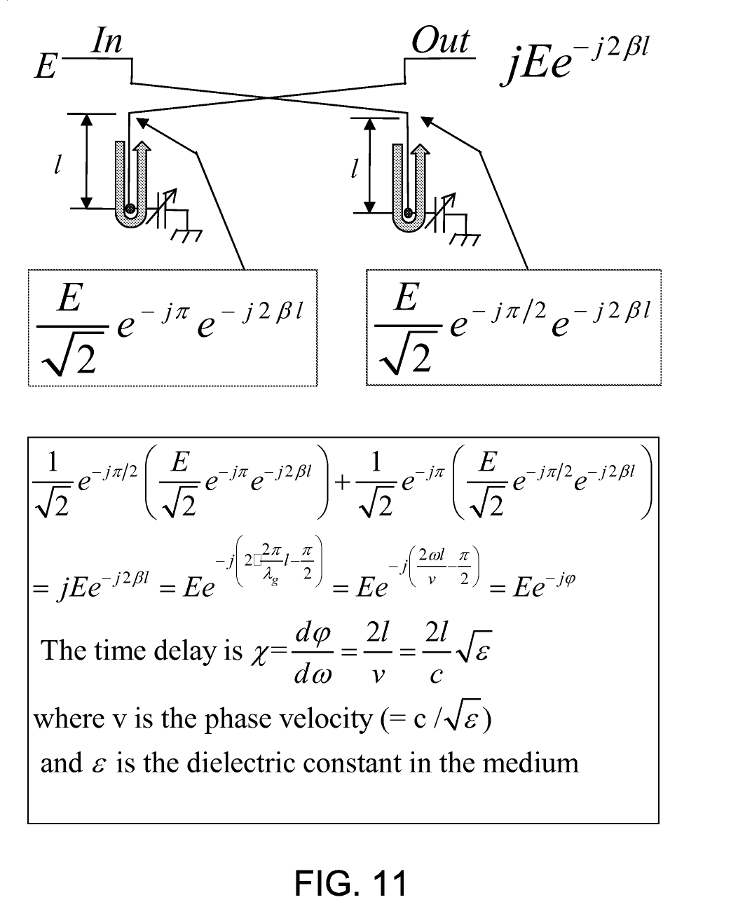

As illustrated in FIG. 11, for line length/to the short circuit (i.e., switches in both transmission lines are shorted at this length), each transmission line reflects its signal back to the hybrid coupler and these signals are combined at the hybrid's output port. For transmission lines of length l in a medium in which the phase velocity is v, the time delay is proportional to 2l/v. For example, in free space, v=c=the speed of light. In a transmission line with effective dielectric constant, ∈, ν=c/\sqrt{∈}. The round-trip time delay of the signal in the transmission line, when written as a phase delay, is e^{-j2βl}, where β=2π/λ_{g} and λ_{g} is the guide wavelength of the reflected signal. The hybrid coupler recombines the reflected signals at the output.

In this example, the output has a phase delay proportional to twice the line length to the short, (i.e., Eₒᵤₜ=jEe^{-jβ2l}). The phase vs. frequency may be linear with a non-zero slope. That is, the round trip time delay (2l/v) will be equal to (a constant plus) the delta phase (dφ) per delta frequency (dω), i.e., 2l/v=dφ/dω.

The time delay device 21 in FIG. 10 includes four programmable delays (e.g., lengths), but larger or smaller numbers of delays (i.e., sets of switches) may be implemented. In one variation, a digital control device, such as a binary decoder, may provide a number of discrete control lines to select discrete phase delays (i.e., sets of switches). In this context, “phase” can be a phase variation with frequency that is equivalent to a given time delay, at least for a finite bandwidth. In the circuit of FIG. 10, a 2 bit decoder may be used to generate four select signals (not shown), one for each set of switches. The number of bits for the device is a trade among several factors including the phase resolution and insertion loss.

Using the time delay device 21 in the circuits of FIG. 1 and FIG. 5, various embodiments may electronically adjust the tilt angles and directions of the receive beam and the transmit beam, which may be orthogonal to the receive beam, by controlling the binary digital decoder or other control device to select the appropriate phase shifts and time delays for each element of the electronically steerable array.

The time delay device 21 may be realized, in various embodiments, with various types of transmission lines including stripline, coaxial line, waveguide, and microstrip. In one embodiment, the circuit may be implemented as micro-electromechanical systems (MEMS) devices. MEMS switches and high dielectric substrates may be used for the switches 22a-22h and transmission lines respectively, where multiple devices may be fabricated in large quantities on wafers using processes similar to those for monolithic microwave integrated circuits (MMICs). Further embodiments may include the entire beam steering and polarization control circuit 16 implemented as a single MEMS “chip”.

One embodiment using MEMS devices can be made extremely compact and manufacturable by incorporating micro-coax and/or micro-waveguide fabrication to interface MEMS devices with other array components such as delay lines, filters and even the radiating elements. In various examples, a MEMS device may be a micro-machined structure fabricated using a process of depositing and etching metals and/or dielectrics on a substrate. In some examples, a micro-coax and/or micro-waveguide may have a rectangular cross-section, although other cross-sections are possible. Micro-coaxial circuits and micro-waveguides may have extremely small size and low insertion loss compared with typical stripline or microstrip structures. In various examples, the micro-structure, whether a micro-waveguide, micro-coaxial circuit, or combination thereof, may have width and length dimensions ranging from tens of micrometers up to several millimeters and very low insertion losses because they are essentially air-filled structures.

Various embodiments of time delay device 21 include MEMS devices, which can have insertion loss values at the Ku-band and the Ka-band of less than 1 dB. If the insertion loss is low (e.g., less than 1 or 2 dB) the array may be largely implemented as a passive antenna at least through the polarization and beam control device, thereby reducing cost and power consumption as well as reducing thermal dissipation problems, and induced noise problems.

In some embodiments, time control devices 15, implemented as MEMS devices (e.g., control device 21), and the hybrid coupler devices 14 may be integrated into a single microcircuit package, module, and/or chip. For example, time control devices 15 and hybrid coupler devices 14 in the form of MEMS devices may be printed/depositied and connected in the configuration of circuit 16 on the same dielectric substrate and packaged as a single integrated circuit. Further, various embodiments may include multiple circuits 16 as integrated MEMS devices printed/depositied on the same dielectric substrate as part of circuits for multiple array antenna elements.

The foregoing description of embodiments has been presented for purposes of illustration and description. The foregoing description is not intended to be exhaustive or to limit embodiments to the precise form disclosed, and modifications and variations are possible in light of the above teachings or may be acquired from practice of various embodiments.

For example, while communication with a satellite using a Ku band array has been described, other embodiments include the disclosed circuits applied to other communication systems, array geometries, and frequencies. Certain embodiments may include, for example, the above-described circuits used within aeronautical, terrestrial, maritime, and/or other spacecraft communication systems

Various embodiments may include the above-described circuits in antenna element electronics for various frequency bands, including, but are not limited to the L-band, S-band, C-band, X-band, Ku-band, K/Ka-band, and Q band. Still further embodiments may operate over multiple bands.

The embodiments discussed herein were chosen and described in order to explain the principles and the nature of various embodiments and their practical application to enable one skilled in the art to utilize the present invention in various embodiments and with various modifications as are suited to the particular use contemplated. All embodiments need not necessarily achieve all objects or advantages identified above. All permutations of various features described herein are within the scope of the invention.

1. An apparatus comprising:
a dual polarized radiating antenna having first and second polarization ports;
first and second hybrid couplers each having first, second, third and fourth ports; and
first and second time delay control circuits each having first and second ports, wherein:
the first and second ports of the first hybrid coupler are respectively connected to the first and second polarization ports of the radiating antenna,
the first and second ports of the first time delay control circuit are respectively connected to the third port of the first hybrid coupler and third port of the second hybrid coupler,
the first and second ports of the second time delay control circuit are respectively connected to the fourth port of the first hybrid coupler and fourth port of the second hybrid coupler, and
the first and second ports of the second hybrid coupler are respectively configured to receive a transmit and output a receive signal.

2. The apparatus of claim 1, wherein:
the time delay control circuit is configured to couple signals bidirectionally between its first and second ports at a first programmable time delay; and
the time delay control circuit is configured to couple signals bidirectionally between its first and second ports at a second programmable time delay.

3. The apparatus of claim 2, wherein:
for a specific first programmable time delay, a change in phase shift of signals coupled through the first time delay control circuit is proportional to a change in frequency of the signals coupled through the first time delay control circuit; and
for a specific second programmable time delay, a change in phase shift of signals coupled through the second time delay control circuit is proportional to a change in frequency of the signals coupled through the second time delay control circuit;

4. The apparatus of claim 2, the apparatus is configured to:
receive the receive signal with a first polarization state;
output substantially all power of the receive signal from the second port of the second hybrid coupler;
isolate substantially all power of the receive signal from the first port of the second hybrid coupler; and
radiate the transmit signal with a second polarization state orthogonal to the first polarization state of the receive signal.

5. The apparatus of claim 4, wherein the first and second polarization states are controllable based on a programmable difference between the first and second programmable time delays.

6. The apparatus of claim 5, further comprising a controller configured to program the programmable difference between the first and second programmable time delays to control the specific polarization state.

7. The apparatus of claim 6, wherein the controller is configured to vary the difference between the first and second programmable time delays to create an elliptical polarization of the antenna.

8. The apparatus of claim 6, wherein the controller is configured to adjust the difference between the first and second programmable time delays to correct for a degradation in axial ratio of the receive signal power and transmit signal power.

9. The apparatus of claim 1, wherein the first and second time delay control circuits include one or more micro-electromechanical system (MEMS) devices.

10. The apparatus of claim 9, wherein the one or more micro-electromechanical system devices and the first and second hybrid couplers are integrated onto a single microcircuit dielectric substrate.

11. The apparatus of claim 1, wherein the first and second time delay control circuits each comprises one or more programmable length transmission lines forming variable time-delay elements.

12. The apparatus of claim 11, wherein:
the first time delay control circuit is configured to:
receive a first receive signal component at its first port and a first transmit signal component at its second port,
couple the first receive signal component and the first transmit signal component to the one or more transmission lines,
receive a reflection of the first receive signal component and first transmit signal component from the one or more transmission lines, and
couple the reflection of the first receive signal component to its second port and the reflection of the first transmit signal component to its first port; and
the second time delay control circuit is configured to:
receive a second receive signal component at its first port and a second transmit signal component at its second port,
couple the second receive signal component and the second transmit signal component to the one or more transmission lines,
receive a reflection of the second receive signal component and second transmit signal component from the one or more transmission lines, and
couple the reflection of the second receive signal component to its second port and the reflection of the second transmit signal component to its first port.

13. The apparatus of claim 11, wherein the one or more programmable length transmission lines comprise micro-coaxial lines and programmable switches configurable to short the micro-coaxial lines at interval lengths.

14. An electronically steerable array antenna comprising two or more copies of the apparatus of claim 1, wherein the first and second time delay control circuits of each copy are configurable to align a receive beam at a receive frequency with a transmit beam at a transmit frequency.

15. The electronically steerable array antenna of claim 14, wherein the first and second time delay control circuits of each copy are configurable to receive the receive signal on the two or more copies at a first polarization state and radiate the transmit signal from the two or more copies at a second polarization state orthogonal to the specific tilt angle.

16. A method performed with an electronically steerable antenna array having two or more identical antenna transceivers, each transceiver comprising:
a dual polarized radiating antenna having first and second polarization ports;
first and second hybrid couplers each having first, second, third and fourth ports; and
first and second time delay control circuits each having first and second ports, wherein:
the first and second ports of the first hybrid coupler are respectively connected to the first and second polarization ports of the radiating antenna,
the first and second ports of the first time delay control circuit are respectively connected to the third port of the first hybrid coupler and third port of the second hybrid coupler,
the first and second ports of the second time delay control circuit are respectively connected to the fourth port of the first hybrid coupler and fourth port of the second hybrid coupler, and
the first and second ports of the second hybrid coupler are respectively configured to receive a transmit signal and output a receive signal;
the method comprising:
selecting a polarization state;
determining a delta time between a first time delay of the first time delay control circuit and a second time delay of the second time delay control circuit in each transceiver to receive the receive signal on each antenna with the selected polarization state; and
program the first and second time delay control circuits of each transceiver such that the first and second time delays of each transceiver maintain the delta time.

17. The method of claim 16, further comprising:
select a beam direction;
determine a unique time offset for each transceiver to form a receive beam and transmit beam in the selected beam direction; and
program the first and second time delay control circuits of each transceiver to include the determined unique offset for that transceiver.

18. The method of claim 16, further comprising:
determining signal parameters of an elliptical polarization;
determining a varying delta time between the first time delay and the second time delay in each transceiver to receive the receive signal polarized with the elliptical polarization on each antenna; and
program the first and second time delay control circuits of each transceiver with the first and second time delays such that each transceiver maintains the varying delta time.

19. The method of claim 16, further comprising:
determining a degradation in axial ratio for each transceiver; and
adjusting the first and second time delays in each transceiver to correct for the degradation in the axial ratio.
